(19) United States
(12) Patent Application Publication
(10) Pub. No.: US 2010/0182605 A1
(43) Pub. Date: Jul. 22, 2010

(54) OPTICAL FLUID DETECTOR

(75) Inventors: Paul Gregory Andrew Stockwell, Berkshire (GB); Nick Adam Leonard, Berkshire (GB)

Correspondence Address: CONLEY ROSE, P.C.;David A. Rose, P. O. BOX 3267, HOUSTON, TX, 77253-3267, US

(73) Assignee: BRAMBRIDGE LIMITED, Bramley, Tadley (UK)

(21) Appl. No.: 12/593,485

(22) PCT Filed: Mar. 27, 2008
(86) PCT No.: PCT/GB08/01105

§ 371 Date: Mar. 22, 2010

(30) Foreign Application Priority Data
Mar. 28, 2007 (GB) 0705932.2

(51) Int. Cl. G01N 21/31

(52) U.S. Cl. 356/436

(57) ABSTRACT

A fluid detector and a method of detecting a fluid are described. The fluid detector includes a broadband light source (10) for providing a light beam (12) including light of at least a predetermined bandwidth, and an optical power detector (40) arranged to provide an output signal indicative of the total power of incident light. An optical path extends from the light source to the optical power detector. The optical path includes a tunable optical filter (20) and a fluid sampling region (30). The tunable optical filter is a tunable optical band-rejection filter, and has a rejection band narrower than the bandwidth of the light beam. The rejection band is swept across the wavelengths of the predetermined bandwidth of the light beam. The tunable optical filter may comprise a fiber Bragg grating.

The present invention relates to fluid detectors, and in particular to optical fluid detectors, as well as to methods of operation and manufacture of such detectors.

Many fluid sensors, analysers or detectors utilise absorption spectroscopy to make qualitative and/or quantitative measurements of chemical constituents present in a fluid sample (e.g. sample of gas or liquid).

Each chemical constituent in a fluid has a characteristic optical absorption spectrum. The specific chemical species present within a fluid can therefore be detected by illuminating the gas or liquid sample, and determining the resulting absorption of light at specific wavelengths, or as a function of wavelength.

For example a known type of gas detector includes a tunable light source to irradiate a gas sample. A detector is positioned to determine the power (or intensity) of the light after it has been transmitted through the sample. Such a detector can be a relatively simple power detector. The absorption spectrum of the sample can be determined by detecting the power of the source transmitted through the sample, as the tunable light source is swept through different wavelengths. The chemical constituents of the sample can then be determined by analysis of the absorption spectrum. For example, the sample absorption at particular wavelengths may be analysed, to determine the presence (or absence) of predetermined chemical species.

Typically, the light source will be a tunable diode laser (TDL), such as a DFB (Distributed Feed-Back) TDL. DFB TDL's allow the sample to be illuminated at a series of different specific wavelengths, with relatively high wavelength selectivity. Thus, the light source can be tuned to provide light at the specific wavelengths corresponding to specific absorption lines of different chemical species, allowing a high accuracy in determining which chemical species are present in the sample.

A known disadvantage of such a system is the relatively high cost of tunable light sources, such as tunable diode lasers. This cost limits the application of such gas sensors to critical measurements, and prevents the use of such gas detectors in many high volume markets.

It is an aim of the embodiments of the present invention to provide a fluid detector that addresses one or more problems of the prior art, whether described herein or otherwise. It is an aim of specific embodiments of the present invention to provide a relatively low cost fluid detector.

In a first aspect, the present invention provides a fluid detector comprising: a broadband light source for providing a light beam comprising light of at least a predetermined bandwidth; an optical power detector arranged to provide an output signal indicative of the total power of incident light across at least said predetermined bandwidth; and an optical path extending from the light source to the optical power detector, the optical path comprising a tunable optical filter, and a fluid sampling region, wherein the tunable optical filter is a tunable optical band-rejection filter having a rejection band narrower than said bandwidth of the light beam.

Such a fluid detector allows the use of a relatively low cost broadband light source, in conjunction with a relatively low cost tunable optical filter. The broadband light source could comprise one or more lasers of lower cost than the tunable lasers currently used. For example, the tunable optical filter can be a tunable Fibre Bragg Grating. As well as allowing the use of relatively low cost equipment, such a fluid detector potentially allows the scanning over wider tunable wavelength ranges, and over wavelength ranges beyond the wavelength ranges that are readily available using DFB TDL's.

Said tunable optical filter may reject a band of incident radiation by reflection.

Said tunable optical filter may comprise a flexible grating.

Said tunable optical filter may comprise a Fibre Bragg Grating.

The fluid detector may further comprise a control circuit arranged to control the tunable optical filter to sweep the rejection band across the wavelengths of said predetermined bandwidth of the light beam.

Said control circuit may be arranged to apply a ramped control signal to said tunable optical filter to control the filter to perform said sweep, the control circuit being further arranged to apply a predetermined amplitude modulation of a predetermined frequency on to the control signal, for improving the detection accuracy.

Said control circuit may be arranged to control the output power of the broadband light source, so as to modulate the power of the light beam at a predetermined frequency, for improving detection accuracy.

The optical path may further comprise at least one optical reference element, arranged to inhibit at least one wavelength of light within the predetermined bandwidth of the light beam from being transmitted to the optical power detector.

Said at least one optical reference element may comprise a reference cell comprising a material that absorbs light at said at least one wavelength.

Said at least one optical reference element may comprise a Fibre Bragg Grating arranged to reflect light at said at least one wavelength.

The fluid detector may further comprise at least two of said optical reference elements, each optical reference element arranged to prevent a different wavelength of light from being transmitted to the optical detector.

Said Fibre Bragg Gratings may be formed within a single optical fibre.

Said optical power detector may be arranged to provide an output signal indicative of the total power of incident light as a function of a wavelength associated with the position of the rejection band.

The optical detector may comprise signal processing apparatus arranged to provide an output signal indicative of the chemical composition of fluid within the fluid sampling region, by determining wavelengths associated with the position of the rejection band at which the total power detected by the optical detector increases.

Said signal processing apparatus may be arranged to demodulate the signal indicative of the total power of incident light, at an integral multiple of said predetermined frequency.

Said signal processing apparatus may comprise a memory arranged to store data indicative of the absorption spectra of different chemical species, the signal processing apparatus being arranged to compare the signal output from the optical power detector with said stored data, to determine chemical species present within a fluid sample within the fluid sampling region, and to output information regarding the determined chemical species.

The fluid detector may further comprise at least a second fluid sampling region.

The fluid detector may further comprise: a second optical power detector arranged to provide an output signal indicative of the total power of incident light, and wherein the optical path further comprises an optical circulator located between the light source and the tunable optical filter, the optical circulator being arranged to direct incident light from the light source along the optical path towards the tunable optical filter, and to direct incident light reflected from the tunable optical filter towards the second optical power detector.

In a second aspect, the present invention provides a method of detecting a fluid comprising: providing a light beam comprising light of at least a predetermined bandwidth along an optical path to an optical power detector, the optical path comprising a tunable optical filter and a fluid sampling region containing a fluid; moving a rejection band of the tunable optical filter across said predetermined bandwidth of the light beam, the rejection band being narrower than said predetermined bandwidth; and detecting the light incident upon the detector; and providing an output indicative of the total power of light incident upon the optical power detector across at least said predetermined bandwidth as the rejection band is moved across said predetermined bandwidth.

The method may further comprise the step of determining the concentration of a chemical species present within said fluid from said output and data indicative of the absorption characteristics of said species.

In a third aspect, the present invention provides a method of manufacturing a fluid detector, the method comprising: providing a broadband light source for providing a light beam comprising light of at least a predetermined bandwidth; providing an optical power detector arranged to provide an output signal indicative of the total power of incident light across at least said predetermined bandwidth; and providing an optical path extending from the light source to the optical power detector, the optical path comprising a tunable optical filter, and a fluid sampling region, wherein the tunable optical filter is a tunable optical band-rejection filter having a rejection band narrower than said bandwidth of the light beam.

Preferred embodiments of the present invention will now be described, by way of example only, with reference to the accompanying figures, in which:

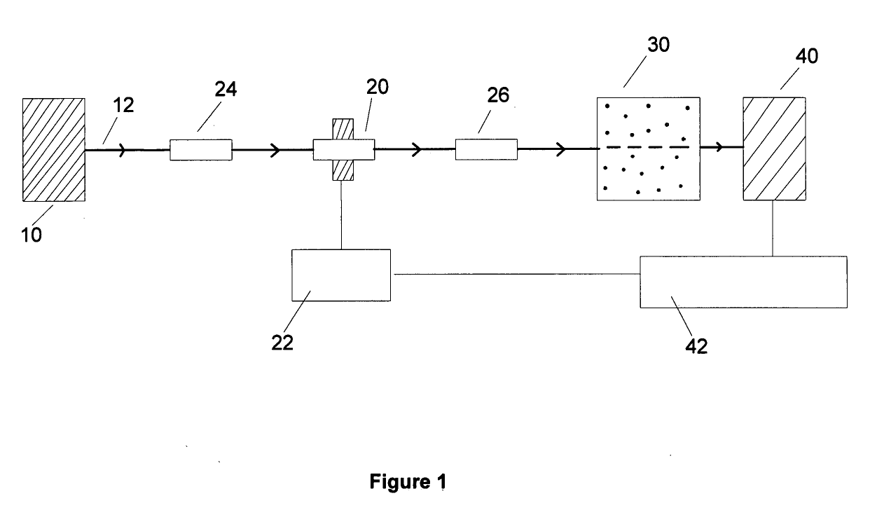

FIG. 1 is a schematic diagram of a fluid detector in accordance with a preferred embodiment of the present invention;

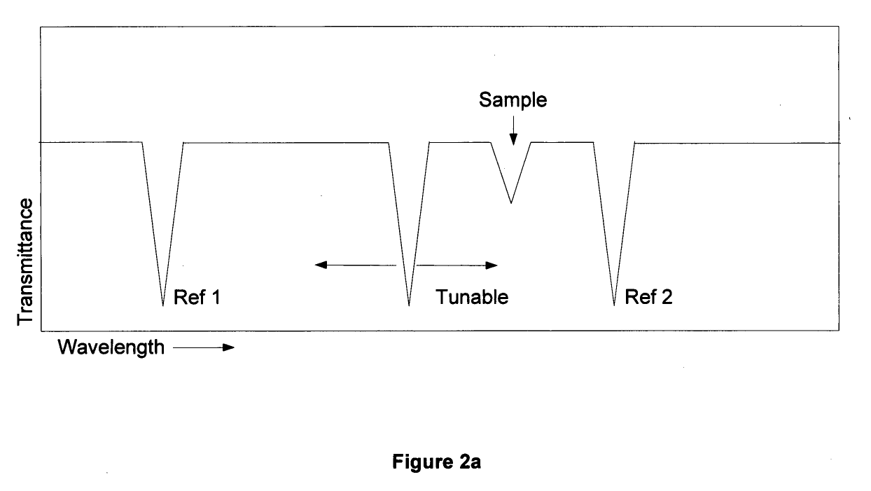

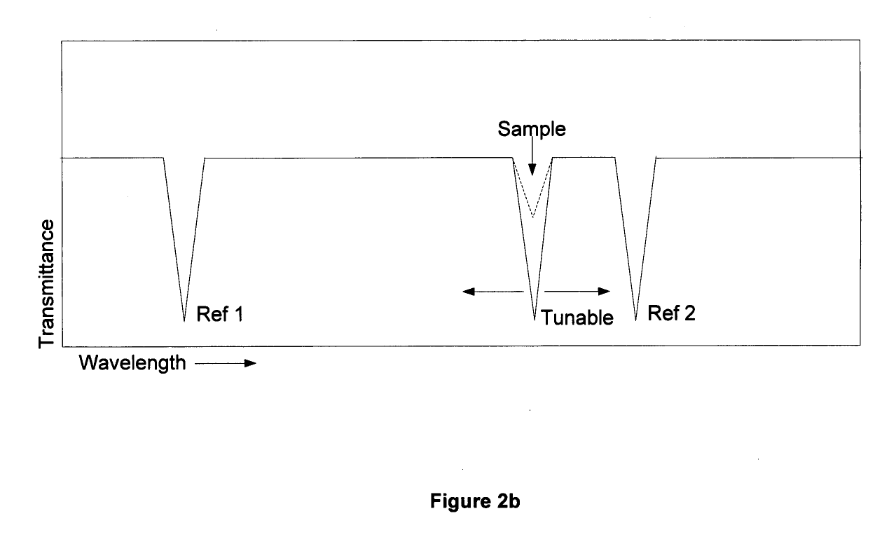

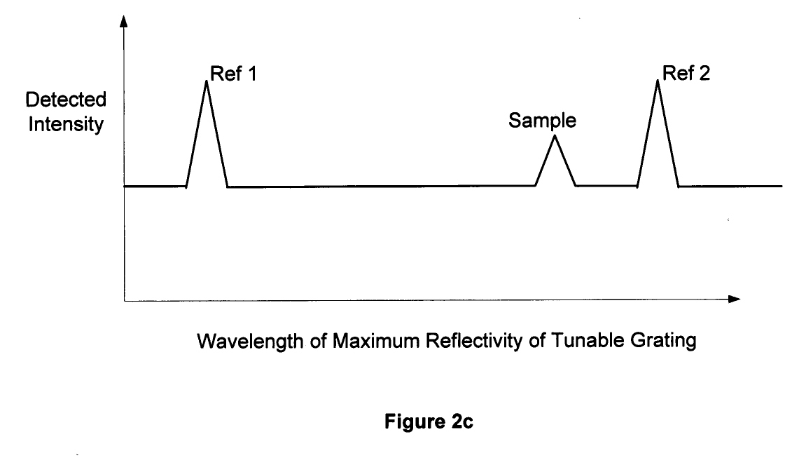

FIGS. 2a & 2b are charts indicating the relative transmittances of the different components within the fluid detector of FIG. 1, with the rejection band of the tunable Fibre Bragg Grating at two different wavelengths;

FIG. 2c is a graph of the intensity detected by the detector of FIG. 1 as the rejection band of the tunable grating is swept across a range of wavelengths;

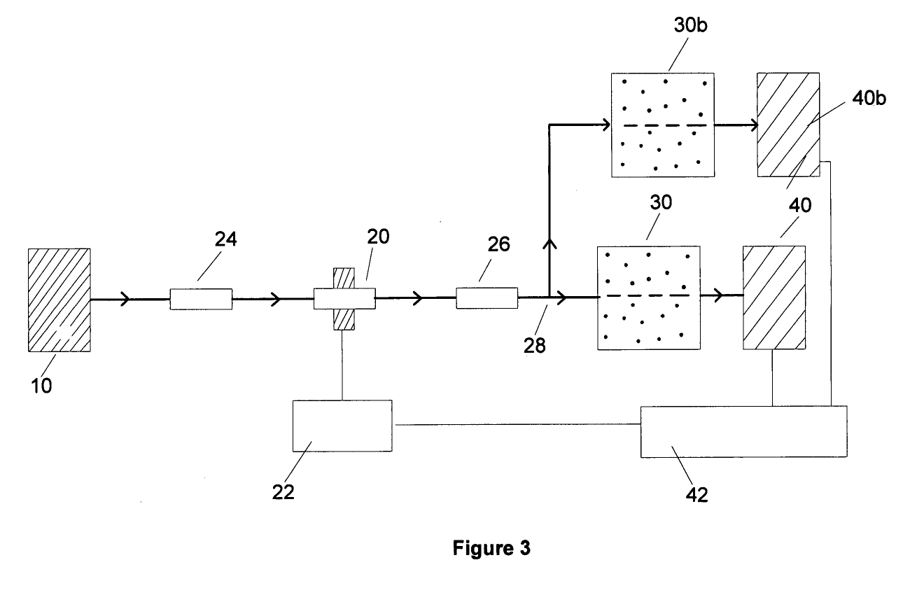

FIG. 3 is a schematic diagram of a fluid detector in accordance with another embodiment of the present invention;

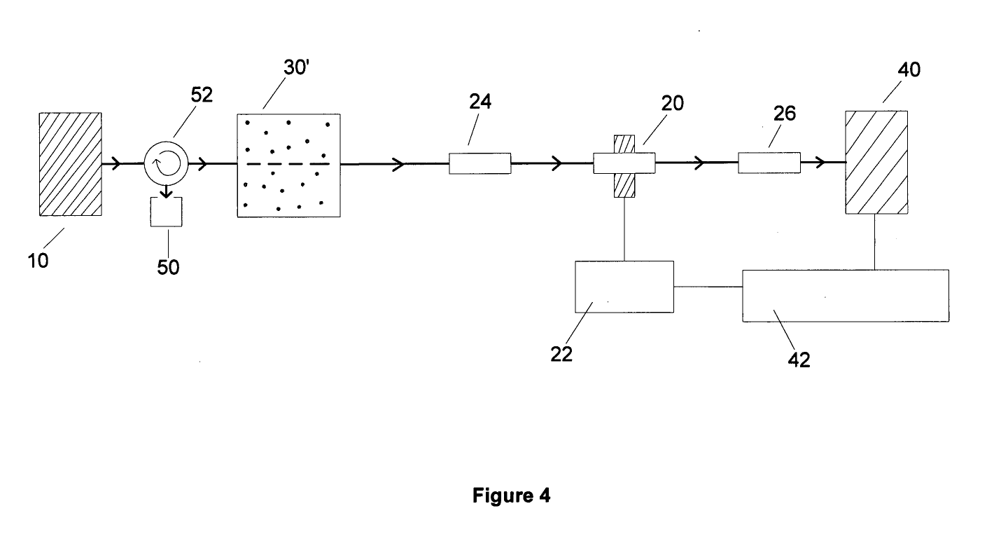

FIG. 4 is a schematic diagram of a fluid detector in accordance with a further embodiment of the present invention; and

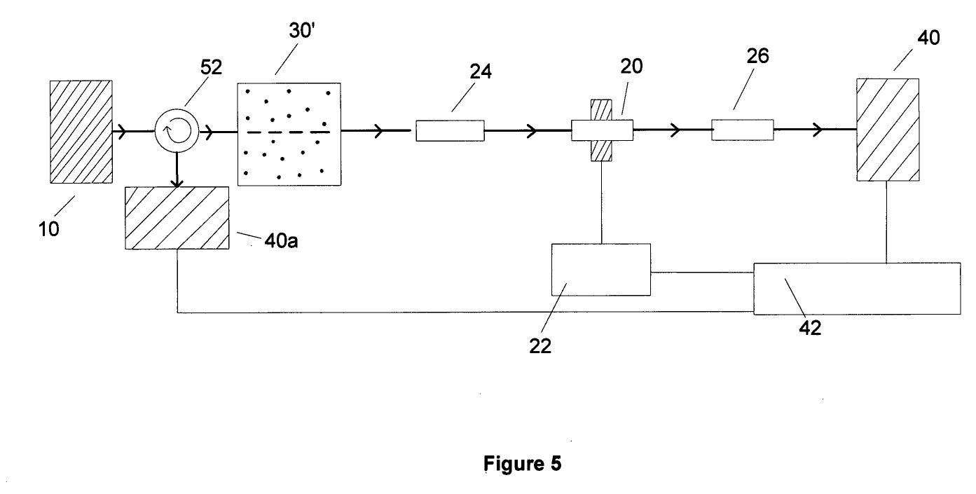

FIG. 5 is a schematic diagram of a fluid detector in accordance with another embodiment of the present invention.

FIG. 1 illustrates a fluid detector in accordance with a preferred embodiment of the present invention.

The fluid detector includes a broadband light source 10 arranged to provide a light beam 12. The light beam 12 comprises light having a substantially continuous range of wavelengths across a predetermined bandwidth. Preferably, the light beam has a substantially uniform intensity across the bandwidth. This light beam is used to measure the absorption spectrum (or at least absorption characteristics at specific wavelengths) of a fluid sample. Thus, the bandwidth of the light beam must extend across at least the wavelengths of interest of the chemical specie(s) which it is desired to detect the presence and/or quantity of, within the fluid sample. It should be noted that the light beam need not consist of only light within the predetermined bandwidth, but could contain light having other wavelengths.

Preferably, the predetermined bandwidth is at least 10 nanometers wide, and more preferably greater than 50 nanometers wide. For an even wider bandwidth capability several of the devices could be designed to run on adjoining wavelengths ranges to give a wavelength range of over 100 mm, or even more 200 mm. Embodiments of the present invention can thus provide relatively wide tuning ranges compared with conventional tunable diode laser systems that have a range of around 4 nanometers. The predetermined bandwidth could lie within any part of the electromagnetic spectrum in which it is desirable to measure the absorption of a particular chemical species. For example, depending upon the desired application, the predetermined bandwidth could lie within the x-ray, ultraviolet or microwave portions of the electromagnetic spectrum. However, in most implementations the predetermined bandwidth will lie within the visible or infrared portion of the electromagnetic spectrum, and in particular can lie within the near infrared spectrum. For example, typically the predetermined bandwidth will lie within the wavelength range 600 to 3500 nanometers.

The fluid detector further comprises an optical power detector 40. The optical power detector is arranged to detect the power of incident radiation, and provide an output signal indicative of the total power of the incident light, or at least the total power of the incident light having a wavelength within the predetermined bandwidth. For example, an optical filter could be placed at the output of the light source 10, arranged to transmit wavelengths of light within the predetermined bandwidth, and attenuate wavelengths outside of that bandwidth. Equally, such a filter could be integral to the light source 10 or placed elsewhere within the beam path from the broadband light source 10 to the detector 40 e.g. adjacent to the input of the detector 40.

An optical path extends from the light source 10 to the optical power detector 40. The light beam output by the light source 10 follows this optical path. Within FIG. 1, the optical path is indicated as an arrowed line extending between the detector components 10, 24, 20, 26 & 30. It should be appreciated that the optical path actually extends through the intermediate components 24, 20, 26 & 30.

A fluid sampling region 30 is located in the optical path. The fluid sampling region is a region in which a fluid sample can be located for measurement of the optical absorption properties thereof. The region 30 could include a vessel arranged to hold a discrete sample of the fluid (e.g. a cuvette). Alternatively, the region could include a conduit along which the fluid is arranged to flow, either as a continuous flow process, or as a stop-flow process. Such a region would be particularly useful in monitoring for contamination of the fluid by one or more undesirable chemical species within fluid processing systems. Equally, it should be appreciated that the region need not comprise a single vessel or conduit, but could include a plurality of vessels or conduits arranged in series or in parallel in the optical path (e.g. for detection of fluid contamination by undesirable chemical species). The fluid can be a gas or a liquid.

A tunable optical filter 20 is also located in the optical path. The tunable optical filter 20 is a tunable band-rejection filter. The band-rejection filter 20 attenuates (“rejects”) signals within a predetermined range or band (i.e. a predetermined wavelength, or range of wavelengths), while freely transmitting optical wavelengths outside of this range. The relevant wavelength(s) can be attenuated due to absorption of light by the optical filter, or by reflection of light from the optical filter. The band-rejection filter 20 is arranged to transmit the majority of incident light received from the broadband light source 10 along the optical path towards the optical power detector 40 and to only reject light having wavelengths within the rejection band. As the optical filter 20 is a tunable optical filter, the position of the band with the optical spectrum (e.g. as may be indicated by the centre wavelength within the band) can be varied.

The rejection band of the tunable filter is narrower than the predetermined bandwidth of the light beam. The rejection band is effectively used to select wavelengths of interest, and hence the desired/actual width of the rejection band will be dependent upon the spectral absorption lines that it is desired to detect within the fluid. Typically, the rejection band of the tunable filter 20 will be at least a factor of 20, if not two orders of magnitude or more, narrower than the predetermined bandwidth of the light beam. For example, if the predetermined bandwidth of the light beam lies within the visible or the near infrared portion of the electromagnetic spectrum then the rejection band could be 3 nanometers or less, or even 1 nanometer or less, or 0.5 nanometer or less.

The tunable optical filter could be formed of any flexible grating, such as a foil, polymer or MEMS (Micro Electro Mechanical system) based flexible grating.

Most preferably, the tunable optical filter 20 is formed by a Fibre Bragg Grating. Such gratings are formed by varying the effective refractive index in the core of an optical fibre. Perturbation of the refractive index leads to the reflection of light in a narrow range of wavelengths, for which the Bragg condition is satisfied. Typically, the reflection bandwidth of such a fibre grating is less than 1 nanometer, but can be varied depending on both the length and the strength of the refractive index modulation. Implementation of the filter 20 as a Fibre Bragg Grating will result in the rejected wavelengths being reflected back towards the source 10.

The wavelength of maximum reflectivity (e.g. which will typically be the centre wavelength of the rejection band) can be varied by temperature and/or mechanical strain. For example, a heater or a cooler, or any device that utilises the thermoelectric effect (e.g. a peltier element) could be arranged to control the temperature of the grating, and hence tune the grating. Thus, the position of the rejection band can be controlled by controlling the temperature and/or mechanical strain applied to the Bragg Grating. In the preferred embodiment illustrated in FIG. 1, the tunable grating is a Fibre Bragg Grating, with a mechanical strain application device arranged to control the mechanical strain applied to the optical fibre. For example, a piezoelectric element or crystal could be utilised.

The position of the rejection band of the filter 20 is controlled by a control circuit 22. The control circuit 22 is arranged to control the filter 20 (e.g. arranged to apply a control signal such as a ramp or sine wave voltage signal to a piezoelectric or peltier element), so as to sweep the position of the rejection band across the wavelengths of the predetermined bandwidth of the light beam 12.

To assist with calibration of the position and/or amplitude of the rejection-band (e.g. the wavelength of maximum reflectivity of the filter 20), at least one optical reference element is located within the optical path. The optical reference element is arranged to prevent (or at least inhibit) at least one wavelength of light within the predetermined bandwidth of the light beam 12 from being transmitted to the optical power detector 40. The reference element could take the form of a reference cell arranged to absorb a predetermined wavelength e.g. a glass or sapphire cell containing a predetermined gas could be utilised.

Any number of optical reference elements could be provided. In this particular embodiment, two optical reference elements are provided. The elements are Fibre Bragg Gratings 24 & 26. As per the tunable Fibre Bragg Grating 20, the Fibre Bragg Gratings are arranged to transmit the majority of incident light received from the source, and reflect a narrow bandwidth (which can be of similar width to the rejection band of the tunable optical filter, or can be narrower) back towards the light source 12. Each optical reference element 24, 26 is arranged to prevent/inhibit a different wavelength (or different band) of light from being transmitted to the optical power detector 40. Thus, the rejection bands/wavelengths of the optical reference elements act as reference marks within the power output signal, as the rejection band of the tunable filter 20 is swept (or otherwise moved) over those wavelengths. Further explanation of this concept is given below, with references to FIGS. 2a-2c.

To allow analysis of the output signal provided by the optical power detector 40, a signal processing apparatus 42 is coupled to the detector 40. The signal processing apparatus 42 is also, in this embodiment, coupled to the control circuit 22, so as to obtain information indicative of the times at which the control signal controls the tunable optical filter to sweep the rejection band across the predetermined wavelength range of the light beam (i.e. the predetermined bandwidth of the light beam). Such information can be used to start and end measurements of the absorption spectrum data.

The signal processing apparatus 42 is arranged to receive the output signal indicative of the total power of incident light from the detector 40, and to analyse the variation in the total power as the rejection band sweeps across the predetermined range of wavelengths of the light beam (or as the rejection band jumps between predetermined positions within that range of wavelengths e.g. wavelengths corresponding to absorption lines of chemical species of interest). From the variation in total power as the wavelength position of the rejection band is altered, the signal processing apparatus can determine at which wavelengths the fluid sample absorbs light i.e. the characteristic absorption spectrum (or particular absorption lines) of the chemical constituents within the fluid sample. The signal processing apparatus further comprises a memory, storing data indicative of the absorption spectra (e.g. particular absorption lines) of different chemical species. Thus, by comparing the signal output from the optical power detector with the stored data, the signal processing apparatus can determine which chemical species are present within the fluid sample. The apparatus 42 can also determine the concentration of such chemical species from the amplitudes of the power output signal. The signal processing apparatus then outputs this information to a user e.g. via a screen or printout.

It should be appreciated that the signal output by the power detector is different from the signals output by known gas detectors.

Typically, such prior art gas detectors use a narrow band tunable light source to irradiate a gas sample at specific wavelengths. The absorption spectrum of the gas sample can be determined, by measuring the variation in the power transmitted through the sample, as the tunable source is tuned across a range of wavelengths. As the wavelength of light passes through an absorption wavelength of the gas sample, the power of the light incident upon the power detector will drop. As previously mentioned, tunable light sources are relatively expensive.

By way of contrast the fluid detector of FIG. 1 utilises a broadband light source 10, arranged to provide a light beam 12 comprising a continuous range of wavelengths across a predetermined bandwidth. The light source 10 can be arranged to provide coherent or incoherent light e.g. it could be a laser system arranged to output a relatively broad spectrum of light, or it could be a lamp.

A measurement of the absorption spectrum of the fluid (e.g. gas or liquid) located within a sampling region in the optical path, can be performed by controlling the band-rejection filter 20 to sweep the rejection band across the bandwidth of incident light (or at least a portion thereof). In direct contrast to typical prior art techniques, and counter-intuitively, a spectral absorption line within the fluid sample will be indicated by an increase in the total power detected by the optical power detector.

A more detailed explanation of the effects of optical elements within the optical path, and the total power detected by the power detector, will now be given with reference to FIGS. 2a-2c.

FIGS. 2a and 2b show the relative transmittances of the optical elements/components as a function of wavelength, at two different positions of the rejection band of the tunable filter. The transmittance of a component is the ratio of energy transmitted by that component to the energy incident on that component. FIGS. 2a & 2b thus show all of the different transmittances of the optical components within the optical path between the light source 10 and the detector 40. The illustrated wavelength range can be regarded as the range of wavelengths corresponding to the predetermined bandwidth of the light beam 12. The two reference elements 24, 26 have respective low transmittances (Ref 1 & Ref 2) at different respective wavelengths.

In this example, it is assumed that the fluid sample present in the fluid sampling region 30 absorbs light strongly around a single predetermined wavelength (marked by the word “Sample”). The tunable optical filter 20 has a low transmittance, the minimum of which corresponds to the wavelength of maximum reflectivity of the tunable Fibre Bragg Grating. As the rejection band of the tunable optical filter 20 is swept across the predetermined wavelength range of the light beam, the transmittance profile (which has a profile corresponding to the inverse of the rejection band) also correspondingly moves. In FIG. 2a, the transmittance profile of the tunable optical filter (labelled “tunable”) is positioned between the wavelengths of the first reference element 24 (Ref 1), and the absorption wavelength of the sample, whilst in FIG. 2b the rejection band overlaps the absorption band of the sample. It should be appreciated that the transmittance profiles of the different optical components are unlikely to be triangular in actual implementations of the invention.

FIG. 2c shows the variation in intensity (power) detected by the detector 40, as the rejection band of the tunable grating 20 is swept across the predetermined bandwidth of the light beam 12. In the illustrated example, for ease of explanation, it is assumed that the light source 10 provides a light beam 12 having a uniform intensity across the predetermined bandwidth. The x-axis of the graph is indicated as a function of the wavelength of maximum reflectivity of the tunable grating, which will generally correspond approximately to the centre of the rejection band. It will be seen that there are three peaks in the detected intensity. Two of the peaks (labelled Ref 1 & Ref 2) correspond to the wavelengths when the tunable filter overlaps with the wavelengths at which the optical reference elements inhibit light from being transmitted to the optical power detector.

The third peak (labelled “Sample”) corresponds to the increase in detected optical power as the rejection band overlaps with the absorption wavelengths of the fluid sample 30. The actual shape of the intensity peak, as a function of wavelength, corresponds to the inverse of the convolution of the shape of the rejection band with the shape of the absorption spectrum of the sample. Thus, if the rejection band is relatively narrow (i.e. if it approximates a delta function, such as a dirac delta function or Kronecker delta, compared with the absorption spectrum of the sample), then the relative increase in intensity as the rejection band sweeps through the absorption wavelengths of the sample will be approximately the same shape as the absorption spectrum (in actual fact, it will correspond to an inverted profile of the absorption spectrum).

Thus, the fluid detector can detect the absorption spectrum of the fluid sample, by sweeping the position of the rejection band through the predetermined bandwidth of the light beam 12 from the light source. Signal processing may also compensate or adjust for the shape of the rejection band and/or the power spectrum of the light source and/or the variation in sensitivity with wavelength of the detector, to optimise the signal. For example, if desired/necessary, the signal processing apparatus can be arranged to deconvolute the shape/profile of the rejection band from the shape/profile of the detected power, so as to obtain the specific absorption spectrum of the relevant species. It should be appreciated that the fluid probe need not sweep the rejection band across the entire predetermined range of interest, but could alter the position of the rejection band (i.e. the wavelength of maximum reflectivity) to overlap with specific predetermined wavelengths. The relevant intensities of the total power can then be detected at those predetermined wavelengths, and hence the presence or absence of predetermined chemical species within the fluid sample determined by the signal processing apparatus 42.

It should be appreciated that the above embodiment is described by way of example only, and that various alternative implementations of the invention will be apparent to the skilled persons as falling within the scope of the appended claims, based upon the teaching herein. It should be noted that within the Figures, identical reference numerals are utilised to represent similar features.

For example, although the wavelength of maximum reflectivity (i.e. the position of the rejection band) of filter 20 can be smoothly swept through the wavelengths of the predetermined bandwidth of the light source which provides a light beam 12 of uniform power, in an alternative implementation a predetermined modulation signal is overlayed on to the ramp control signal provided by control circuit 22 and/or the power the light beam 12 is amplitude modulated with a predetermined modulation signal.

The pre-determined modulation signal(s) could be a sine wave or any other periodic function at a pre-determined frequency. The amplitude of modulation is relatively small compared to the amplitude of the signal to which it is applied. For example, the amplitude of the modulation signal applied to the ramp control signal would be less than the amplitude of the ramp control signal (for example, by an order of amplitude or more), or the modulation of the amplitude of the power of the light beam 12 would be similarly smaller than the total power amplitude of the light beam. Modulation of the power the light beam could be achieved either by modulating the power applied to the light source 10, or by utilising an optical element of variable transmission placed on the output from the light source 10.

If the pre-determined signal is applied to the ramp control signal of the tunable filter, then instead of the filter 20 smoothly sweeping through the wavelengths of the pre-determined band width, the pre-determined modulation signal results in a small oscillation of the wavelength position of the filter as the sweep is performed.

If the pre-determined modulation signal is applied to modulate the output power of the light source 10, then a small ripple will be observed on the total output power from the light source as a function of time.

In either case, upon detection of the resulting total power, the signal processing apparatus is arranged to demodulate the total power output signal, at an integral multiple of the predetermined frequency f (e.g. using a 2f demodulation system or similar), thus allowing a potential increase in the accuracy and/or lower limit of detection of the fluid detector.

Additional apparatus may be added to the configuration of the fluid detector illustrated in FIG. 1. For example, in respect of the embodiment illustrated in FIG. 1, it was described how the sample region 30 could comprise multiple samples e.g. multiple conduits or vessels, each potentially containing a different sample. Such an implementation would be particularly useful in detecting the contamination of fluids within a fluid process, but does not allow the easy identification of the individual contaminated samples. An alternative implementation is illustrated in FIG. 3, in which the optical path to the detector 40 is split (e.g. by a beam splitter) at position 28. Position 28 corresponds to a position between two portions of the optical path, with the light source 10 and the tunable optical filter on the first portion of the optical path, and the fluid sampling region 30 and detector 40 on the second portion. The optical path is split, such that a portion of the light beam is transmitted through the sampling region 30, with the resulting transmitted power being detected by detector 40.

The other portion of the split light signal is directed along a second leg of the optical path, through a second fluid sampling region 30b, with the resulting transmitted power being detected by a second power detector 40b. As per detector 40, detector 40b is arranged to provide an output signal indicative of the total incident detected power, to signal processing apparatus 42. Thus, the fluid within fluid sampling region 30b can be detected, and the relevant chemical species therein identified, as can the fluid and the chemical species within the fluid sampling region 30. It will be appreciated that the fluid detection system illustrated in FIG. 3 could be further modified, with any number of additional legs of the optical path being provided from position 28, with each leg containing a respective fluid sampling region positioned in front of an optical power detector. Thus, the light source, the tunable optical filter, and any optical reference elements present, can all be utilised to provide an optical signal for detection of the chemical species within any number of different samples.

In FIG. 1, the optical components 20, 24, 26, 30 are illustrated as being in a particular order within the optical path that extends from the light source 10 to the power detector 40. However, these components 20, 24, 26 & 30 could in fact be in any order. Additional components could be inserted within, the optical path, as desired. For example, as illustrated in FIG. 4, the fluid sampling region (here labelled 30′, as it is placed in a different location) could be located in a different portion of the optical path distant from the optical power detector 40 i.e. with the tunable optical filter between the fluid sampling region 30′ and the power detector 40 (as opposed to the tunable optical filter 20 being between the light source 10 and the fluid sampling region 30).

The fluid detection illustrated in FIG. 4 comprises a further optical component located in the optical path, in the form of an optical circulator 52. The optical circulator 52 is located in the optical path between the light source 10, and the tunable optical filter 20 and fluid sampling region 30. The optical circulator 52 is arranged to direct incident light from light source 10 along the remainder of the optical path, towards the fluid sampling region 30′, tunable filter 20 and detector 40. The circulator 52 is arranged to direct any light received from the direction of the power detector (i.e. light due to reflection from the optical filter 20 or the optical reference elements 24, 26) out of the optical path, into an optical sink 50 (i.e. a body or black box used to absorb any light). Thus, any light reflected from the tunable filter 20 or the optical reference elements 24, 26 is removed from the optical path.

In an alternative embodiment illustrated in FIG. 5, the circulator 52 has the same function. In this embodiment, the fluid sampling region 30′ is again located between the optical circulator 52 and the tunable filter 20. However, in this particular implementation the optical circulator 52 is arranged to direct (reflected) light from the tunable filter 20 into an additional power detector 40a. As per power detector 40, power detector 40a is arranged to measure the total intensity of incident light. In this case, the incident light will comprise light reflected from the tunable optical filter 20 and the optical references 24 & 26, which has not been absorbed by fluid within the sampling region 30′. Thus, the reflected light will give a further indication of the absorption spectrum of the fluid within the sampling region 30′, as the reject position of the rejection band of the tunable filter 20 is varied. The signal from the detector 40a is transmitted to the signal processing apparatus 42. Comparing the two signals from the two detectors 40, 40a potentially allows an increase in accuracy of the resulting spectral measurements e.g. it could improve the signal to noise ratio of the analysis.

The absorption of the light beam is measured by transmitting the light beam through the fluid. In the above embodiments, the light beam is illustrated entering on one side of the fluid sampling region, and exiting upon the other, opposite side of the fluid sampling region. However, it should be appreciated that the optical path need not extend completely through the fluid sampling region. For example, the absorption characteristics of the fluid could be measured using attenuated total reflectance (ATR) techniques. In ATR, a probe is placed in contact with the fluid to be sampled e.g. the probe is immersed in the fluid, or some of the fluid is pumped or poured on to a probe surface. A beam of light is provided into the probe such that it reflects off at least one internal surface of the probe that is in contact with the sample. This reflection forms an evanescent wave which extends into the sample. The absorption of the fluid can then be detected by detecting the intensity of the reflected light beam leaving the probe. Thus, in a particular preferred arrangement, so as to allow ATR to be performed, the fluid sampling region comprises an attenuated total reflectance probe.

1. A fluid detector comprising:
a broadband light source for providing a light beam comprising light of at least a predetermined bandwidth;
an optical power detector arranged to provide an output signal indicative of the total power of incident light across at least said predetermined bandwidth; and
an optical path extending from the light source to the optical power detector, the optical path comprising a tunable optical filter, and a fluid sampling region,
wherein the tunable optical filter is a tunable optical band-rejection filter having a rejection band narrower than said bandwidth of the light beam.

2. The fluid detector as claimed in claim 1, wherein said tunable optical filter rejects a band of incident radiation by reflection.

3. The fluid detector as claimed in claim 1, wherein said tunable optical filter comprises a flexible grating.

4. The fluid detector as claimed in claim 2, wherein said tunable optical filter comprises a Fibre Bragg Grating.

5. The fluid detector as claimed in claim 1, further comprising a control circuit arranged to control the tunable optical filter to sweep the rejection band across the wavelengths of said predetermined bandwidth of the light beam.

6. The fluid detector as claimed in claim 5, wherein said control circuit is arranged to apply a ramped control signal to said tunable optical filter to control the filter to perform said sweep, the control circuit being further arranged to apply a predetermined amplitude modulation of a predetermined frequency on to the control signal, for improving the detection accuracy.

7. The fluid detector as claimed in claim 5, wherein said control circuit is arranged to control the output power of the broadband light source, so as to modulate the power of the light beam at a predetermined frequency, for improving detection accuracy.

8. The fluid detector as claimed in claim 1, wherein the optical path further comprises at least one optical reference element, arranged to inhibit at least one wavelength of light within the predetermined bandwidth of the light beam from being transmitted to the optical power detector.

9. The fluid detector as claimed in claim 8, wherein said at least one optical reference element comprises a reference cell comprising a material that absorbs light at said at least one wavelength.

10. The fluid detector as claimed in claim 8, wherein said at least one optical reference element comprises a Fibre Bragg Grating arranged to reflect light at said at least one wavelength.

11. The fluid detector as claimed in claim 8, comprising at least two of said optical reference elements, each optical reference element arranged to prevent a different wavelength of light from being transmitted to the optical detector.

12. The fluid detector as claimed in claim 8, or any claims dependent thereto, wherein said Fibre Bragg Gratings are formed within a single optical fibre.

13. The fluid detector as claimed in claim 1, wherein said optical power detector is arranged to provide an output signal indicative of the total power of incident light as a function of a wavelength associated with the position of the rejection band.

14. The fluid detector as claimed in claim 1, wherein the optical detector comprises signal processing apparatus arranged to provide an output signal indicative of the chemical composition of fluid within the fluid sampling region, by determining wavelengths associated with the position of the rejection band at which the total power detected by the optical detector increases.

15. The fluid detector as claimed in claim 14, wherein said signal processing apparatus is arranged to demodulate the signal indicative of the total power of incident light, at an integral multiple of said predetermined frequency.

16. The fluid detector as claimed in claim 14, wherein said signal processing apparatus comprises a memory arranged to store data indicative of the absorption spectra of different chemical species, the signal processing apparatus being arranged to compare the signal output from the optical power detector with said stored data, to determine chemical species present within a fluid sample within the fluid sampling region, and to output information regarding the determined chemical species.

17. The fluid detector as claimed in claim 1, further comprising at least a second fluid sampling region.

18. The fluid detector as claimed in claim 2, the fluid detector further comprising:
a second optical power detector arranged to provide an output signal indicative of the total power of incident light, and
wherein the optical path further comprises an optical circulator located between the light source and the tunable optical filter, the optical circulator being arranged to direct incident light from the light source along the optical path towards the tunable optical filter, and to direct incident light reflected from the tunable optical filter towards the second optical power detector.

19. A method of detecting a fluid comprising:
providing a light beam comprising light of at least a predetermined bandwidth along an optical path to an optical power detector, the optical path comprising a tunable optical filter and a fluid sampling region containing a fluid;
moving a rejection band of the tunable optical filter across said predetermined bandwidth of the light beam, the rejection band being narrower than said predetermined bandwidth; and
detecting the light incident upon the detector; and
providing an output indicative of the total power of light incident upon the optical power detector across at least said predetermined bandwidth as the rejection band is moved across said predetermined bandwidth.

20. The method as claimed in claim 19, further comprising:
determining the concentration of a chemical species present within said fluid from said output and data indicative of the absorption characteristics of said species.

21. A method of manufacturing a fluid detector, the method comprising:
providing a broadband light source for providing a light beam comprising light of at least a predetermined bandwidth;
providing an optical power detector arranged to provide an output signal indicative of the total power of incident light across at least said predetermined bandwidth; and
providing an optical path extending from the light source to the optical power detector, the optical path comprising a tunable optical filter, and a fluid sampling region,
wherein the tunable optical filter is a tunable optical band-rejection filter having a rejection band narrower than said bandwidth of the light beam.
